(19) United States
(12) Patent Application Publication
(10) Pub. No.: US 2005/0104343 A1
(43) Pub. Date: May 19, 2005

(54) Side airnet cushioning/ restraint device

(76) Inventor: Mark Levine, Bloomfield, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/716,997

(22) Filed: Nov. 19, 2003

(51) Int. Cl. B60R 21/22

(52) U.S. Cl. 280/730.2

(57) ABSTRACT

A side airnet cushioning and restraint device for a vehicle configured to be inflated and deployed on a side of a vehicle between a front pillar and a rear pillar of the vehicle via an inflator during a side impact accident, a rollover accident, or a side impact and a rollover accident, the side airnet comprising: an inflatable net operatively connected to the inflator having a top edge secured at a point above the vehicle's side windows and between the front pillar and the rear pillar, and a lower edge extending below the vehicle's side windows and between the front pillar and the rear pillar; a cable tensioner operatively connected to the inflater; a retention cable anchored at the front pillar and the rear pillar and fed through guides near the lower edge of the inflatable net and operatively engaged by the cable tensioner.

### FIELD OF THE INVENTION

The present invention relates to a combined side impact/rollover protection device. More specifically, the present invention is directed to an inflatable, self-tensioning side air bag like device that provides side impact protection, rollover protection, and both side impact and rollover protection.

### BACKGROUND OF THE INVENTION

Like front impact airbags, side impact airbags of various types were known and described many years prior to their commercial introduction. Currently, while side airbags are not as ubiquitous as front airbags, most manufacturers offer them as either an option or standard equipment depending on the type and cost of the vehicle.

Current side airbags such as described in U.S. Pat. No. 6,168,191 and 6,390,502 may be designed to protect a vehicle occupant from a side impact, a rollover, or both. Such bags fastened to the edge of the roof between the front and rear pillars. In some the corners of the bag are tethered with static cords to an area located around the lower corners of the front and rear windows. When a side impact, rollover, or both is detected via appropriate sensors the air bag control system triggers an inflator that fills the side airbag. The tethers and chambers in the bag may be configured (such as via a back and forth lacing configuration as shown in U.S. Pat. No. 6,390,502) so that as the bag reaches full inflation the tethers are tensioned and the lower portions of the bag secured.

Such passively tethered systems, unfortunately, have a number of drawbacks. If the window is down or broken, the tension on the tethers and/or the stiffness of the inflated bag may be insufficient to prevent an occupant's head and upper body from being forced outside the vehicle. Should they airbag get punctured (a significant possibility if the window is broken) or any time after the bag deflates, tension on the tethers is lost and the bag is essentially inoperable. The likelihood of puncture or deflation of the airbag in a rollover increases due to an increased probability that the side window glass as well as the relatively extended time required for a rollover event.

### SUMMARY OF THE INVENTION

One object of the invention is a side airbag design that is not supported by the closed window.

Another object of the present invention is a side airbag system in which tensioning of the corners of the bar is independent of the bag's inflation state.

Still another object of the present invention is a side airbag design that provides side impact and rollover protection even if punctured.

These and other objects of the invention are satisfied by a side airnet cushioning and restraint device for a vehicle configured to be inflated and deployed on a side of a vehicle between a front pillar and a rear pillar of the vehicle via an inflator during a side impact accident, a rollover accident, or a side impact and a rollover accident, the side airnet comprising: an inflatable net operatively connected to the inflator having a top edge secured at a point above the vehicle's side windows and between the front pillar and the rear pillar, and a lower edge extending below the vehicle's side windows and between the front pillar and the rear pillar; a cable tensioner operatively connected to the inflater; a retention cable anchored at the front pillar and the rear pillar and fed through guides near the lower edge of the inflatable net and operatively engaged by the cable tensioner.

### BRIEF DESCRIPTION OF THE DRAWINGS

FIG. 1 is a lateral cut away of a vehicle showing a deployed airnet according to the invention.

FIG. 2 is a lateral cut away of a vehicle showing the airnet of FIG. 1 in a stowed configuration.

### DETAILED DESCRIPTION

The present device is a net like side curtain air bag device referred to herein as an “airnet.” This airnet is designed to protect vehicle occupants from head and upper body injuries in the event of side impacts and/or rollover events. This airnet is configured so that soon after its inflation constant tension is provided regardless of the airnet's inflation state. Thus, it provides a soft “race car” side net that protects a vehicle occupant and assures his head and upper body remain inside the car if the window is down, if the window is broken, if a rollover occurs, and even if the airnet is punctured or after it has deflated.

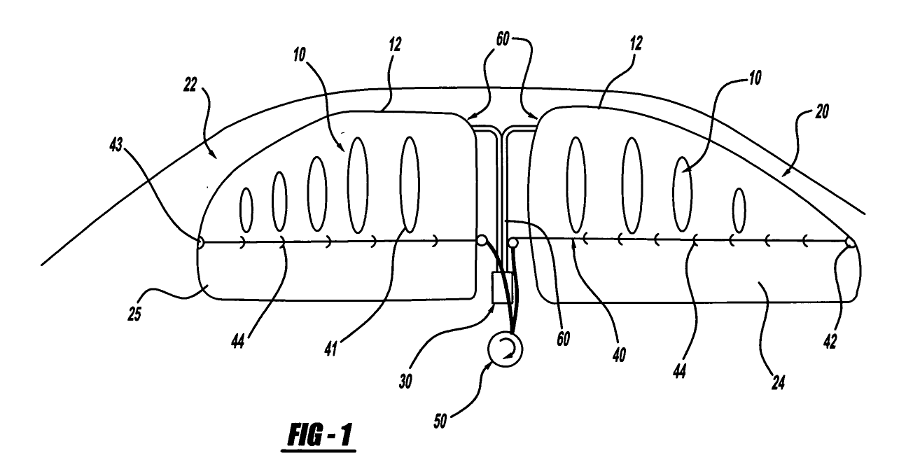

FIG. 1 illustrates a cutaway, longitudinal section of a preferred embodiment of the invention a viewed from inside the vehicle. The airnet 10 is shown deployed between the front pillar 20 and the rear pillar 22. The airnet 10 is secured at its top edge 12 a point above the vehicle's side windows 24, 25. While FIG. 1 illustrates the airnet 10 as having two pieces, the invention is intended to include one piece, two piece, three piece and more depending on such factors as the number of separate windows, the number of seats in the vehicles, general design configurations, etc.

The lower edge of the airnet 10, as shown extends below the side windows 24, 25 exposed bottom edge. Alternatively, the lower edge of the airnet 10 may extend to the lower edge of the windows 24, 25. Obviously, design consideration might dictate that a portion of the lower edge of the airnet 10 extends far below the lower edge exposed edges of the windows 24, 25 in one region and even above this point in a different region. It is intended that the invention cover such variations.

As shown in FIG. 1, a retention cable 40 is attached at an anchor point 42 at the front pillar 20 and a second retention cable 41 is attached at an anchor point 43 at the rear pillar 22. Both retention cables 40, 41 feed through guides 44 near the lower edge of the airnet 10 to a cable tensioner 50. Alternative configurations are of course possible and intended to be covered by the present invention. For example, a single retention cable could be attached at the anchor point 42, feed through guides 44 near the lower edge of the airnet 10, and through a pulley mounted at the anchor point 42 before being fed into a cable tensioner 50. The tensioner 50 employs a ratchet or similar type of one-way clutch that is configured to tension the cable 40 and maintain this tension until it is positively released. The retention cable 40 may be fabricated from any very low stretch material such as braided metal cabling or braided plastic cabling IS (such as Spectra® line, a braided poly(p-phenyleneterephtalamide) manufactured by Honeywell International) known in the art.

An inflator 30 is operatively connected to the airnet 10 and the cable tensioner 50. Operation of the inflater 30 is controlled by an air bag sensor and controller system that senses a side impact, a rollover event, or a combination side impact rollover event and activates the inflator 30. Any air bag sensor and controller system known in the art may be used with the present invention.

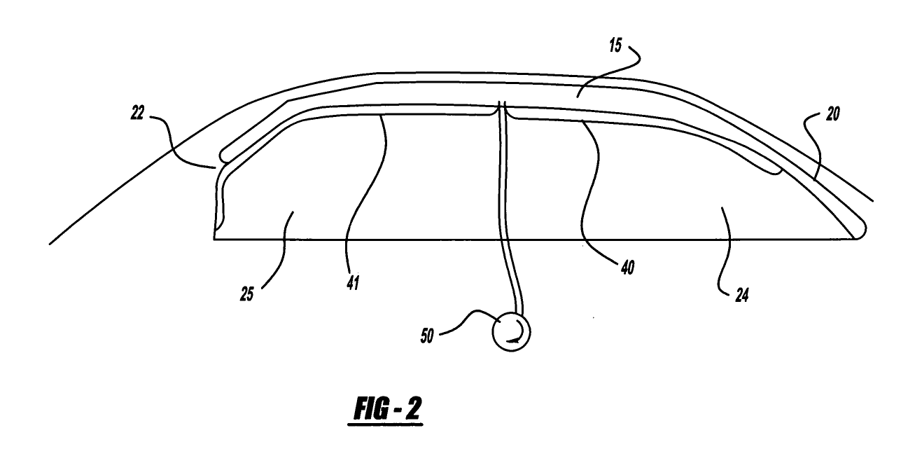

In operation, the airnet 10 is stowed deflated 15, as shown in FIG. 2, along the upper edge of the vehicle between the front pillar 20 and the rear pillar 22. When a side impact, a rollover event, or a combination side impact rollover event is detected by the sensor and controller system, the system generates the appropriate control signal(s) to activate the inflator 30. The inflator 30 inflates the air net 10 deploying it to the position shown in FIG. 1. Simultaneously (or after a specific time delay, depending on specific system configurations) with the inflation and deployment of the airnet 10, the inflator also actuates the tensioner 50 to take up slack in the retention cable 40, 41. With the slack removed from the retention cable 40, 41, the airnet 10 is secured in place across the front window 24 and the rear window 25. Unlike prior art devices that tensioned the cable to hold the side airbag in place only as long as the side airbag was inflated, the configuration of the present invention holds the airnet 10 in place regardless of the state of inflation of the airnet. This represents a significant improvement over the prior art because the present invention permits the occupants to be retained when the airnet is deflated.

The airnet 10 of the present invention may be any of a variety of configurations: a solid bag (similar to a standard side airbag), several solid bags joined or partially joined at their margins, a slotted bag (such as illustrated in FIG. 1), or a bag having the appearance of a net when inflated. Preferably, regardless of the outside appearance of the airnet since the deployed airnet has a support and restraint function whenever it is deployed whether inflated or not, it is preferred that the airnet be fabricated so that it has sufficient strength to perform in this manner. This can be accomplished, for example, by incorporating a reinforcing mesh or net in the airnet. For certain applications, it may also be desirable to incorporate padding or cushioning, such as an open cell foam, that can be compressed when the airnet is stowed, yet will expand when the airnet is deployed to provide additional cushioning after it is deflated.

Control of the ratchet or one-way clutch mechanism of the tensioner 50 may be accomplished via a simple lever that when actuated releases the tensioner or via an electromechanical release that is under the control of the sensor and controller system so that tension on the retaining cable(s) is automatically released, for example, when vehicle motion is no longer detected and/or at a fixed time after the initiating event. It may also be advantageous to use an electromechanical release mechanism that is configured to release only when the seatbelt of the nearest occupant is released or when the seatbelt is release and when the sensor controlling system release conditions are satisfied.

There are a number of specific advantages of the present invention over the prior art. It has extended ‘uptime’ thus providing significantly better rollover protection. It provides rollover and side impact protection. It can be configured to use a single manual release if desired. It can be used with a single inflater. And, it can be used with any hardtop configuration.

The present invention with minor variations could easily be adapted to replace front air bag applications.

It is to be understood that although the invention has been described with particular reference to specific embodiments, the forms of the invention shown and described are to be taken as a non-limiting embodiment and various changes and modifications, such as variations resulting from new materials may be made to the invention without departing from its spirit and scope as described in the Claims.

1. A side airnet cushioning and restraint device for a vehicle configured to be inflated and deployed on a side of a vehicle between a front pillar and a rear pillar of said vehicle via an inflator during a side impact accident, a rollover accident, or a side impact and a rollover accident, said side airnet comprising:
an inflatable net operatively connected to said inflator having
a top edge secured at a point above said vehicle's side windows and between said front pillar and said rear pillar, and
a lower edge extending below said vehicle's side windows and between said front pillar and said rear pillar;
a cable tensioner operatively connected to said inflater;
a retention cable anchored at said front pillar and said rear pillar and fed through guides near said lower edge of said inflatable net and operatively engaged by said cable tensioner.

2. The side airnet cushioning and restraint device of claim 1, where regions of said lower edge extend above said vehicle's side windows and regions of said lower edge extend below said vehicle's side windows.

3. The side airnet cushioning and restraint device of claim 1, where said retention cable tensioner incorporates a one-way clutch that maintains tension on said retention cable until positively released.

4. The side airnet cushioning and restraint device of claim 3, where said one-way clutch further comprises a mechanical release mechanism.

5. The side airnet cushioning and restraint device of claim 3, where said one-way clutch further comprises an electromechanical release mechanism.

6. The side airnet cushioning and restraint device of claim 3, where said one-way clutch further comprises a mechanical release mechanism and an electro-mechanical release mechanism.

7. The side airnet cushioning and restraint device of claim 1, where said one-way clutch further comprises a mechanical release mechanism.

8. The side airnet cushioning and restraint device of claim 1, where said retention cable is fabricated from braided poly(p-phenyleneterephtalamide).

9. The side airnet cushioning and restraint device of claim 1, where said inflatable net is reinforced with a supporting mesh.

10. The side airnet cushioning and restraint device of claim 1, where said inflatable net is reinforced with a supporting net.

11. The side airnet cushioning and restraint device of claim 1, where said inflatable net incorporates open cell foam padding.
